(19) United States
(12) Patent Application Publication
(10) Pub. No.: US 2006/0275002 A1
(43) Pub. Date: Dec. 7, 2006

(54) MODULAR UNIT FOR THE DISTRIBUTION OF THE LIGHT FLOW OF A COLD LIGHT SOURCE

(75) Inventors: Johannes Knoblich, Jena (DE); Thomas Serfling, Jena (DE); Tobias Kaufhold, Jena (DE); Detlef Hein, Goettingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss Microlmaging GmbH

(21) Appl. No.: 11/421,598

(22) Filed: Jun. 1, 2006

(30) Foreign Application Priority Data
Jun. 1, 2005 (DE) 10 2005 024 998.1

(51) Int. Cl. G02B 6/02

(52) U.S. Cl. 385/123

(57) ABSTRACT

The present invention is directed to a modular unit for the distribution of the light flow of a cold light source which makes it possible to combine different illumination methods in mixed-light operation with only one individual high-power cold light source and to switch between illumination methods. In the modular unit according to the invention for the distribution of the light flow of a cold light source, the light flows of a cold light source which are distributed to a plurality of cross sections can be manipulated individually, and elements provided for the manipulation of the light are constructed in such a way that an adaptation possibility for different types of light guides is provided at the output of each individual cross section. Any combinations of optical elements for beam shaping, beam splitting and/or beam guiding can be used to distribute the light flow. In an advantageous construction, a light guide having a large input cross section and a plurality of smaller, output cross sections is used to distribute the light flow of the cold light source. The proposed modular unit for the distribution of the light flow of a cold light source is provided for microscope applications in particular but is also suitable for other applications in which different illumination methods are to be realized individually and in combination using only one light source.

### CROSS-REFERENCE TO RELATED APPLICATION

This application claims priority of German Application No. 10 2005 024 998.1, filed Jun. 1, 2005, the complete disclosure of which is hereby incorporated by reference.

### BACKGROUND OF THE INVENTION

a) Field of the Invention

The present application is directed to a modular unit for the distribution of the light flow of a cold light source which makes it possible to combine different illumination methods in mixed-light operation with only one individual high-power cold light source and to switch quickly and ergonomically between the illumination methods without changing the illumination elements that are used and without resetting the parameters.

b) Description of the Related Art

The essential operator functions of a modern cold light source are described using the example of the KL 2500 LCD by Schott. The main operating controls, a manual rotary switch for presetting the lamp voltage and a rotary knob for a manually rotatable filter diaphragm with an adjustable active cross section, are arranged directly at the cold light source. The lamp voltage can also be preset by means of an optional remote control. While the color temperature and intensity change with lamp voltage, the intensity can also be adjusted in a color-neutral manner by means of the filter diaphragm. According to DE 195 13 350 A1, the filter diaphragm used in this instance generates a homogeneous illumination even in the attenuated state through the special arrangement of holes.

When light guides are used they are held by a collet chuck. Light guides with a receptacle diameter of 17 mm and light guides with a receptacle diameter of 10 mm can be adapted to the KL 2500 LCD. The light guides can also be used to carry out cross-section conversions. For example, multiple-arm light guides having a receptacle diameter for connecting to the cold light source can be used, and the outputs preferably have the same output diameter. The active surface at the light guide input is equal to the sum of the active surfaces at the light guide outputs.

Different types of illumination are required particularly in microscopy. In this connection, it is common to accommodate transmitted light illumination in the stand base with excellent usability. In contrast, the multitude of conventional incident illumination means are offered in modular form.

Cold light sources are frequently used with light guides so that preparations are not thermally stressed unnecessarily. The color temperature and the intensity can be preset by means of the cold light source. The light is transmitted from the light source to the desired location preferably by a flexible light guide with a determined input cross section and can be radiated in an optimized manner for the respective application through the shape of the output cross section.

Conventional cold light illumination elements for incident systems in microscopy include, for example, ring lamps with a plurality of diameter variants and different constructions for brightfield and darkfield, line lamps, one-arm or multiple-arm light guides with or without a focusing attachment, or coaxial incident illumination means. These illumination elements cannot be supplied simultaneously by a single cold light source, which rules out the possibility of mixed-light operation. If an independent cold light source were provided for every possible illumination method, the costs would be considerable.

Because work surface is often limited, larger auxiliary devices such as cold light sources cannot always be arranged in the immediate vicinity of the microscope. But this severely hampers the usability of the cold light source. To ensure ergonomically advantageous usability, the cold light sources would have to possess a remote control.

Although the color-neutral brightness adjustment, as the most common and most important application, should be capable of regulation, the remote control in known cold light sources is limited to regulation of the lamp voltage. However, changing the lamp voltage also changes the color temperature.

It is disadvantageous that the cost of remote control capability in cold light sources is relatively high so that it is offered only for very expensive high-end cold light sources with very high output. Further, commonly available adaptable light guides have smaller outer diameters for cost reasons and for improved flexibility and are therefore not suitable for high outputs.

For this reason, different illumination methods were usually implemented by rearranging the light guides. However, it is disadvantageous that the cold light sources are often poorly accessible and the illumination parameters have to be readjusted after rearranging the light guides. Further, an advantageous mixed-light operation between different illumination methods is impossible when there is only one cold light source.

Modularity offers the advantage of simple retrofitting of individual illumination methods which can be adapted individually to the respective application.

The illumination arrangement described in U.S. Pat. No. 6,280,059 B1 is preferably provided for curing UV adhesives and has at least two outputs for light guides. It is possible to switch between these light guides by means of a mirror. In so doing, the intensity can be varied by small angular deviations because the diaphragm moves along with the mirror and therefore limits the active light guide cross section. This arrangement is disadvantageous in that the intensity of the two outputs cannot be varied independently from one another so that mixed-light operation cannot be implemented.

A reading lamp system for a passenger aircraft is described in U.S. Pat. No. 5,873,644 A. A plurality of reading lamps are supplied with light by a shared cold light source via light guides. The light of each individual reading lamp can be varied by means of a liquid crystal element by changing the transmission of this element through an applied voltage. However, the described system has no adapter for receiving different types of light guides and is not suitable for stereo microscopy.

An arrangement for monitoring objects is described in DE 41 15 841 A1. In this case, partial images of the object to be monitored are acquired by a plurality of light guides, whose object-side ends can be positioned independently from one another relative to the object to be monitored, and are transmitted to an array camera. Although the arrangement provides for many different illumination situations, it is not possible to vary the intensity of illumination for individual light guides independently from one another. It is impossible to provide homogeneous illumination while ensuring a dimming function. Also, this solution does not provide an adapter for receiving different types of light guides. True mixed-light operation cannot be realized with a single light source.

A method and an arrangement for analog, homogeneous dimming of a light flow in an optical beam path is described in EP 0 902 314 A1. In this case, the light is influenced by a suitable electronically controllable element. However, the system has no interface for standardized light guide types. Since a dimming of the light flow is carried out before distributing to a plurality of light guides, the illumination conditions are identical for all light guide ends. The intensity in the individual light guides cannot be varied independently from one another.

DE 199 26 835 A1 describes a lamp in which the light of an individual light source is distributed to a plurality of outputs with different elements for dispersing the light. A special flower-shaped mirror is used for the light distribution. The described lamp has no adapter for receiving different types of light guides. Since the elements for dispersing the light are arranged at the outputs in a stationary manner and are limited in each instance to an individual illumination situation, it is not possible to vary the light ratios at the output.

EP 1 258 768 A2 describes a device for illuminating an observation field by means of two light sources, particularly for use in dentistry. In this case, it is possible to vary the illumination only by switching the individual light sources on and off and/or swiveling in wavelength filters. Steps for color-neutral dimming of the individual light outputs are completely absent. Further, application is limited to two light guide outputs. The cost in apparatus is increased substantially through the use of two light guides. The described solution cannot be used in a flexible manner due to the absence of standardized interfaces for light guides.

U.S. Pat. No. 3,536,908 A describes a decorative device for illumination comprising a stationary light guide “tree”. The inputs of the light guides can be supplied with light of different wavelengths by a light source and a rotating filter segment disk arranged behind the latter. Standardized receptacles for light guides are not provided because a generally stationary arrangement of interconnected light guides, including special reflectors, is used in this instance. Consequently, there are also no steps provided for color-neutral dimming of the individual light outputs. Changing the light by means of the position of the rotating filter segment disk also automatically results in a definite illumination of the other light guides. The proposed arrangement is therefore not suitable for illumination for a stereo microscope.

### OBJECT AND SUMMARY OF THE INVENTION

It is the primary object of the present invention to find an economical, space-saving arrangement that can be operated in an ergonomically advantageous manner in which the light guides need not be switched around and which also enables mixed-light operation by a selected combination of different illumination methods.

According to the invention, this object is met in a modular unit for the distribution of the light flow of a cold light source comprises a plurality of cross sections to which light flows of a cold light source are distributed and can be manipulated individually, and elements for the manipulation of the light are provided and so constructed that an adaptation possibility for different types of light is provided.

For this purpose, in the modular unit for the distribution of the light flow of a cold light source, proceeding from a light guide which is adaptable to the cold light source and which has a large cross section, the light flow is distributed to a plurality of light guides having a small cross section and possessing elements for the manipulation of the light. The elements for the manipulation of the light are constructed in such a way that adaptation possibilities for different types of light guides are provided at the output of each individual cross section.

The proposed modular unit for the distribution of the light flow of a cold light source is provided for microscope applications in particular but is also suitable for other applications in which different illumination methods are to be realized, individually and in combination, using only one light source.

The invention will be described more fully in the following with reference to schematic drawings.

### BRIEF DESCRIPTION OF THE DRAWINGS

In the drawings:

FIG. 1 shows the principle of the distribution of the light flow by means of a special light guide with an input cross section and three output cross sections;

FIG. 2 shows a selection of elements for the manipulation of the light through color-neutral brightness control;

FIG. 3 shows a variant for the color-neutral brightness control by means of a rotating filter diaphragm; and

FIG. 4 shows the arrangement of the elements for the manipulation of the light in the divergent, convergent, or parallel beam path.

### DESCRIPTION OF THE PREFERRED EMBODIMENTS

The light guides to be adapted to the receptacles are referred to hereinafter as standardized light guides. However, any user-specific light guide with appropriate connection can be adapted in the receptacles.

In the modular unit according to the invention for distributing the light flow of a cold light source, the light flows from a cold light source which are distributed to a plurality of cross sections can be manipulated individually, and elements provided for the manipulation of the light are constructed in such a way that means for adapting to different types of light guides are provided at the output of each individual cross section.

Combinations of optical elements for beam shaping, beam splitting and/or beam guiding can be used to distribute the light flow. For example, these optical elements can be a plurality of beamsplitter prisms which are arranged one behind the other. Additional elements for beam shaping are useful.

In an advantageous construction, a light guide having a large input cross section and a plurality of smaller, output cross sections is used to distribute the light flow of the cold light source. This light guide, which is adaptable to the cold light source, has elements for the manipulation of the light which are constructed in such a way that adaptation possibilities for different types of light guides are provided at the output of each individual cross section.

The arrangements described in the following are not limited only to the use of fiber-based light guides but can also be operated with liquid light guides and individual fibers. Any combinations are possible. Light guides of glass, silica glass, or plastic are preferably used. This applies to the adaptable standardized light guides as well as to the light guides for distributing the light flow of the cold light source.

Based on the cold light source KL 2500 LCD which was already described and which has a high output of 250 W, the light is guided by an input light guide with the maximum possible active input diameter of 15 mm. Accordingly, the active surface at the input of the light guide is abut 176.7 mm². The input light guide is divided close to its end into three smaller light guide ends, each having an active surface of the same size. Accordingly, there are three active surfaces of about 58.9 mm² each, with an active diameter of about 8.7 mm in each instance. The connection diameter at the standardized light guides to be adapted results in a maximum possible active diameter of 9 mm.

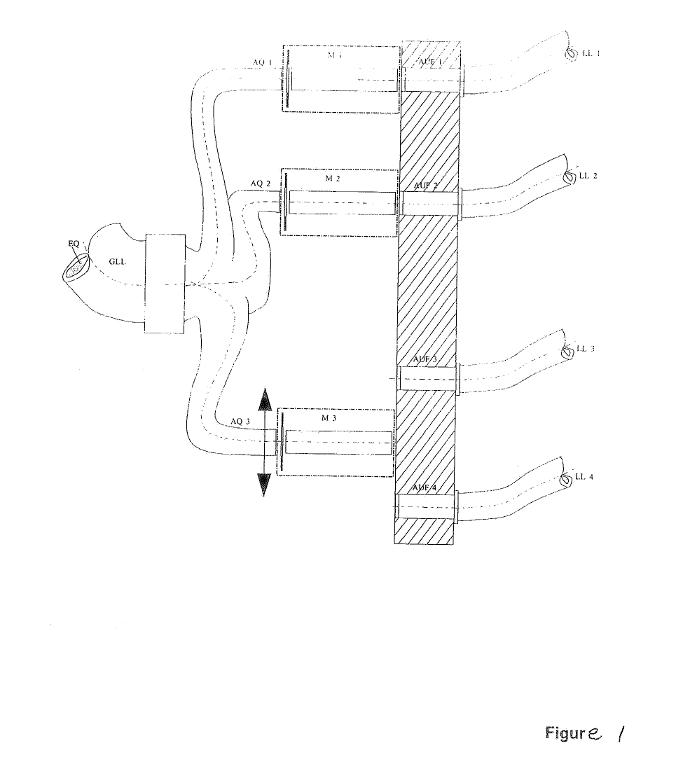

As is shown in FIG. 1, the light flow of a high-power cold light source (not shown), e.g., the KL 2500 LCD mentioned above, is guided by a light guide GLL with the largest possible active input cross section EQ. Due to the characteristic of the cold light source that is used, a sufficiently high illumination intensity which results from the high output, e.g., 250 W, is available over the entire active input cross section EQ.

A special light guide with one or several input cross sections and a plurality of output cross sections adapted to the correspondingly required quantity is provided for distributing the light flow.

According to FIG. 1, the light guide GLL is divided into three smaller light guide ends with cross sections AQ1, AQ2 and AQ3. The three light guide ends are guided to adaptation possibilities AUF1, AUF2, AUF3 and AUF4 for different illumination elements, e.g., standardized light guides LL1, LL2, LL3 and LL4. It is possible to change the illumination elements quickly when needed.

Elements for the manipulation of the light M1, M2 and M3 are arranged between the adaptation possibilities AUF1, AUF2, AUF3 and AUF4 and the three smaller light guide ends of the light guide GLL with cross sections AQ1, AQ2 and AQ3.

The elements for the manipulation of the light M1, M2 and M3 have operator controls which are arranged in such a way that they can be actuated by the user in an ergonomically advantageous manner. The elements for the manipulation of the light M1, M2 and M3 are preferably operated by remote control, and their settings can be stored and activated again.

One or more light guide ends with cross sections AQ1, AQ2 and AQ3 can be constructed in such a way that they can be positioned in front of different adaptation possibilities AUF1, AUF2, AUF3 and AUF4 by displacement. The elements for the manipulation of the light M1, M2 and M3 are arranged in front of the interfaces in a stationary manner or are located at the outputs of the special light guides and moved along with them.

By controlling the elements for the manipulation of the light by means of actuators or stepping motors, the adjustments can be preset and also reproduced with sufficient accuracy. Accordingly, user-specific settings, i.e., those selected by the user, can be stored and quickly activated again when needed. This also includes the possibility of using the settings for the elements for the manipulation of the light for evaluation and further processing.

By means of the elements for the manipulation of the light M1, M2 and M3 which are arranged between the light guide ends and the adaptation possibilities AUF1, AUF2, AUF3 and AUF4, it is possible to attenuate the light of the individual light guide ends through the arrangement of diaphragm elements or filter elements.

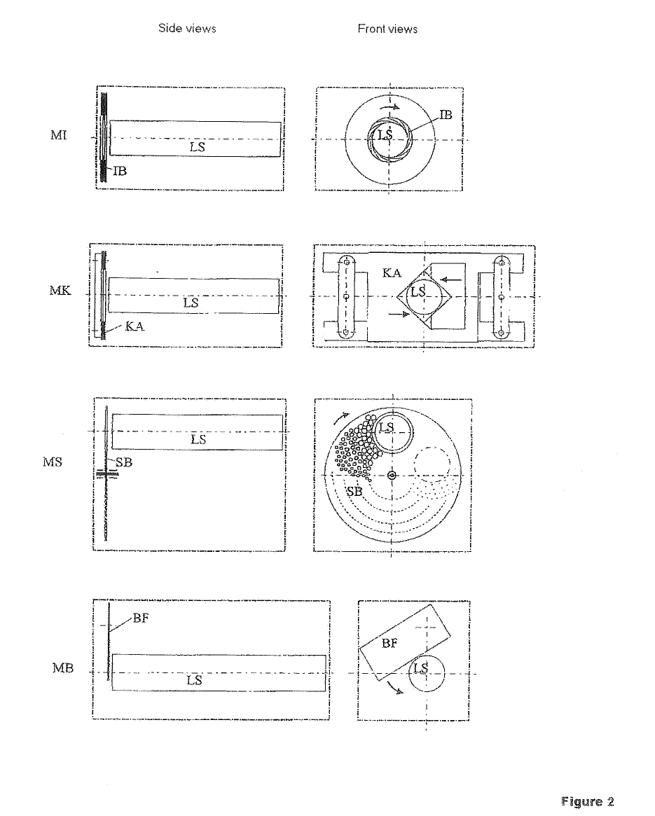

FIG. 2 shows a selection of elements for the manipulation of the light which enables a color-neutral brightness control for each individual cross section. The arrows shown in FIG. 2 indicate the direction in which an element must be adjusted in order to reduce the brightness in a color-neutral manner. The elements for the manipulation of the brightness of the light have diaphragm elements, e.g., iris diaphragms, cat's eye diaphragms, or filter diaphragms.

While module MI contains an iris diaphragm, for example, a cat's eye diaphragm KA is used in module MK to implement a color-neutral brightness control. For this purpose, a filter diaphragm SB similar to the filter diaphragm according to DE 195 13 350 A1 is used in module MS. Light-conducting rods LS are arranged directly behind these elements to improve light mixing.

Even simpler diaphragms are conceivable as further embodiment forms when good light mixing is provided. In the simplest case, for example, in module MB, as is shown in FIG. 2, a diaphragm blade BF which acts on one side and can be slid into or swiveled into the beam path can come from the outside to cover the cross section of the light-conducting rod LS arranged directly behind.

The contour of the diaphragm blade BF covering the beam path can be constructed as a straight edge or as any other desired shape. Accordingly, for example, the active cross section of the light guide can be changed in a relatively sensitive manner by means of a rotatable diaphragm blade BF with a contour that is arranged in a spiral shape around the center of rotation.

In principle, other elements for modification of the light, e.g., wavelength filters, color graduation filters or intensity graduation filters, can be used instead of the attenuation elements described above.

In contrast to the iris diaphragm IB and gray graduation filter, the cat's eye diaphragm KA makes it possible to completely close the cross section. This property is absolutely necessary for true darkfield illumination over an individual active cross section.

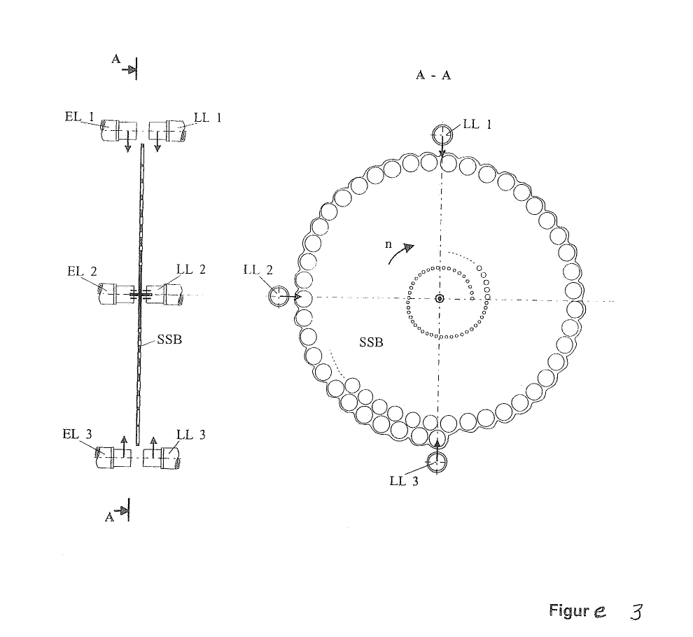

FIG. 3 shows a special constructional variant for color-neutral brightness variation. In this case, the divided ends EL1, EL2 and EL3 of the input light guide are arranged in a radially displaceable manner together with the respectively associated receptacle for the standardized light guides LL1, LL2 and LL3 on a special filter diaphragm SB which permanently rotates at a high rate of rotation n. Due to the radial displacement of the cross sections in the direction indicated by the arrow, the active surface decreases as the radius decreases. The hole pattern of the filter diaphragm SB is selected in such a way that each individual fiber of the active cross section is illuminated in a sufficiently homogeneous manner with constant radial adjustment during a revolution of the filter diaphragm SB. The filter diaphragm SB has holes which are arranged in a spiral shape and whose cross sections increase outwardly. A sufficient light mixing is achieved by means of this advantageous arrangement so that no additional elements such as light-mixing rods are required. Another advantage of this arrangement is that a plurality of light guides can be displaced radially independent from one another on this filter diaphragm SB. The divided ends EL1, EL2 and EL3 of the input light guide can also be light guide ends with cross sections AQ1, AQ2 and AQ3 of the light guide GLL. Further, the standardized light guides LL1, LL2 and LL3 can also have adaptation possibilities AUF1, AUF2, AUF3.

In another constructional variant, the brightness of the light is regulated by varying the position of the elements for the manipulation of the light relative to the active cross section of a graduation filter. This can be implemented by displacement of the graduation filter and simultaneous displacement of the output light guide, together with the light guide receptacle for the standardized light guides arranged downstream, relative to a stationary graduation filter.

When inexpensive standardized light guides in the form of light guide bundles are used, varying the brightness by means of the modules shown in FIG. 2 would result in individual fibers being covered and, therefore, in sudden changes in brightness of entire areas. This is manifested by a flickering that occurs at the output of the standardized light guides in a spatially inhomogeneous manner and indicates a poor-quality illumination. This can be corrected through the use of additional light mixing elements which are preferably arranged directly behind the elements for varying brightness.

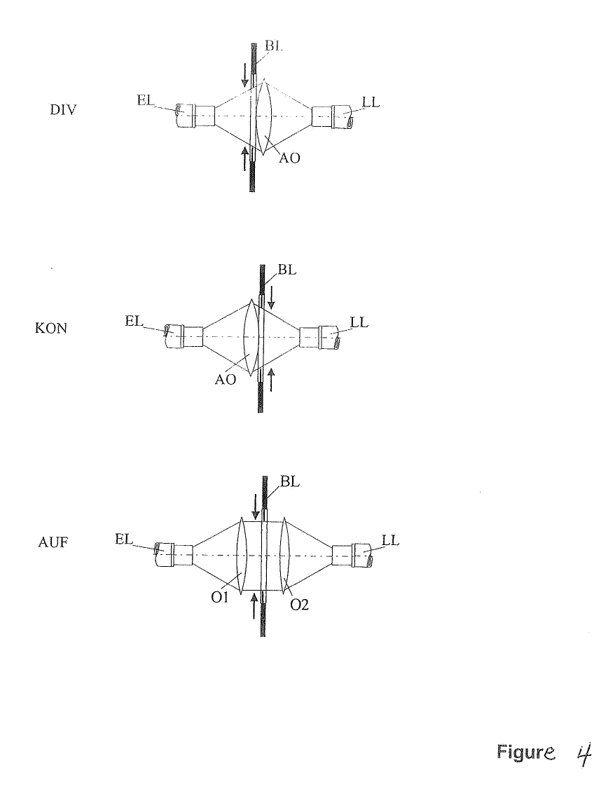

FIG. 4 shows the arrangement of the elements for the variation of brightness in the divergent, convergent, or parallel beam path. The diaphragm BL is arranged between a divided end EL of the input light guide and the standardized light guide LL to be adapted.

When the diaphragm BL is arranged in the divergent beam path DIV and in the convergent beam path KON, the entire light of the cross section is coupled directly into the full cross section of the standardized light guide LL through the expansion optics AO.

In the expanded beam path AUF, the refractive power of the expansion optics AO is divided between the two optical elements O1 and O2 and the diaphragm is then positioned between O1 and O2.

In a particularly advantageous construction, one or more outputs of the special light guide is/are constructed in such a way that it/they can be adapted to different adaptation possibilities by displacement, and the elements for the manipulation of the light are arranged in a stationary manner in front of the adaptation possibilities or are located at the outputs of the special light guide and are moved along with the latter.

According to FIG. 1, the output AQ3 is constructed in such a way that it can be positioned in front of the adaptation possibilities AUF1, AUF2, AUF3 and AUF4 through displacement. The element for the manipulation of the light M3 is arranged at the output AQ3 of the special light guide and is moved along with it in a corresponding manner.

All of the elements for the manipulation of the light are preferably constructed in a modular manner so that they can be changed easily.

The adaptation possibilities AUF are suitable not only for the standardized light guides, but advantageously also for light guide bundles. The light guide bundles that are used can be mixed homogeneously or inhomogeneously. However, for improved light distribution it is advantageous when the individual fibers in the light guide bundles are mixed homogenously. In this way, it can be ensured that the same illumination pattern is provided at the start and at the end of the light guide bundle.

In another advantageous construction, the adaptation possibilities for different types of light guides have a device which prevents light from exiting when no light guide is adapted.

For this purpose, a switch can be arranged at the adaptation possibilities AUF, whose switching state depends on whether or not a standardized light guide is located in the corresponding receptacle AUF. This switching state is used for controlling the elements for the manipulation of the light in such a way that no light arrives at their outputs when no standardized light guide is located in the receptacle AUF. This safeguard function can be implemented electrically or mechanically.

It is also possible to integrate the cold light source in the modular unit. This solution even offers the advantage that the internal light guide bundles need not be protected against mechanical stresses by bulky tubing so that smaller bending radii and smaller housing dimensions result in lower total costs. The cost-intensive mechanical interface between the cold light source and the light guide can also be dispensed with in this case,

The remote controllability of the modular unit for distributing the light flow of a cold light source, particularly of the elements for the manipulation of the light, ensures ergonomic operation through the remote control which is arranged within reach of the user.

When the modular unit is arranged, for example, below the supplying cold light source, no additional work surface is needed. The cold light source can also be positioned at poorly accessible locations thanks to the remote control.

Alternatively, the modular unit can also be arranged directly at the optical instrument, e.g., a stereo microscope, within reach of the user so that the operator controls can be reached easily.

The modular unit could also be a component part of an incident light device and/or transmitted light device. In this case, the manipulation of the light, preferably the light dimming, could take place internally within these subassemblies.

The modular unit, according to the invention, for the distribution of the light flow of a cold light source provides a solution that makes it possible to select different illumination elements, to preconfigure an application, and also to ensure mixed-light operation with only one cold light source by means of the selective brightness preset.

A special advantage of the arrangement consists in the ergonomically advantageous operation. With the modular unit according to the invention, it is no longer necessary to manage one or more cold light sources because the arrangement can be controlled remotely. No additional work surface is required.

Alternatively, the elements for operating the light manipulation can also be arranged in an easily accessible manner directly on the microscope.

The user-specific data, i.e., the settings selected by the user, can be quickly reactivated by suitable control of the motor-actuated elements. This affords an additional, very substantial advantage to the user.

While the foregoing description and drawings represent the present invention, it will be obvious to those skilled in the art that various changes may be made therein without departing from the true spirit and scope of the present invention.

What is claimed is:

1. A modular unit for the distribution of the light flow of a cold light source, comprising:
a plurality of cross sections to which light flows of a cold light source are distributed and can be manipulated individually; and
elements for the manipulation of the light being provided and so constructed that an adaptation possibility for different types of light guides is provided.

2. The modular unit according to claim 1, in which any combinations of optical elements for beam shaping, beam splitting and/or beam guiding are used for dividing the light flow of the cold light source into a plurality of small light flows.

3. The modular unit according to claim 1, in which a light guide having a large input cross section and a plurality of output cross sections with smaller cross sections is used to divide the light flow of the cold light source.

4. The modular unit according to claim 1, in which a special light guide with one or several input cross sections and a plurality of output cross sections that is adapted to the correspondingly required quantity is provided for distributing the light flow.

5. The modular unit according to claim 1, in which one or more outputs of the special light guide is/are constructed in such a way that it/they can be positioned in front of different adaptation possibilities by displacement, wherein the elements for the manipulation of the light are arranged in a stationary manner in front of the interfaces or are located at the outputs of the special light guide and are moved along with the latter.

6. The modular unit according to claim 1, in which the elements for the manipulation of the light have operator controls which are arranged in such a way that they can be operated by the user in an ergonomically advantageous manner.

7. The modular unit according to claim 1, in which the elements for the manipulation of the light are operated by remote control.

8. The modular unit according to claim 1, in which the settings for the elements for the manipulation of the light can be stored and reactivated.

9. The modular unit according to claim 1, in which the settings for the elements for the manipulation of the light can be used for evaluation and further processing.

10. The modular unit according to claim 1, in which the wavelength of the light is manipulated by the elements for the manipulation of the light by means of wavelength filters, preferably a color graduation filter.

11. The modular unit according to claim 1, in which the intensity of the light is manipulated by the elements for the manipulation of the light by means of intensity graduation filters.

12. The modular unit according to claim 1, in which the brightness of the light is varied by the elements for the manipulation of the light by means of diaphragm elements, wherein iris diaphragms, cat's eye diaphragms, or filter diaphragms are used as diaphragm elements.

13. The modular unit according to claim 1, in which the brightness of the light can be varied by the elements for the manipulation of the light by means of a diaphragm blade which acts on one side and which can be slid into or swiveled into the beam path.

14. The modular unit according to claim 1, in which the contour of the diaphragm blade which covers the beam path can be constructed as a straight edge or in any other shape.

15. The modular unit according to claim 1, in which a light mixing element is arranged downstream of the elements for the manipulation of the light.

16. The modular unit according to claim 1, in which the elements for the manipulation of the light are arranged in the parallel, divergent, or convergent beam path.

17. The modular unit according to claim 1, in which the manipulation of the brightness of the light is carried out by relative displacement of the divided ends of the input light guide with the receptacle for the standardized light guides with respect to a graduation filter arranged therebetween.

18. The modular unit according to claim 1, in which the manipulation of the brightness of the light is carried out by relative displacement of the divided ends of the input light guide with the receptacle for the standardized light guides with respect to a rotating filter diaphragm arranged therebetween.

19. The modular unit according to claim 1, in which the manipulation of the brightness of the light is carried out by relative displacement of the divided ends of the input light guide with the adaptation possibility for the standardized light guides with respect to a graduation filter arranged therebetween.

20. The modular unit according to claim 1, in which the elements for the manipulation of the light are constructed in a modular manner and can be changed.

21. The modular unit according to claim 1, in which the individual fibers in the adapted light guide bundles downstream are mixed preferably homogeneously for improved light distribution.

22. The modular unit according to claim 1, in which the adaptation possibilities for different types of light guides have a device that prevents light from exiting when no light guide is adapted.

23. The modular unit according to claim 1, in which the cold light source is integrated.

24. A modular unit for the distribution of the light flow of a cold light source which is integrated in a microscope or is a component part of an incident light arrangement and/or transmitted light arrangement.
